(19) United States
(12) Patent Application Publication
(10) Pub. No.: US 2024/0079717 A1
(43) Pub. Date: Mar. 7, 2024

(54) TRACTION BATTERY PACK VENTING ASSEMBLY AND METHOD OF ESTABLISHING A TRACTION BATTERY PACK VENT PATH

(71) Applicant: Ford Global Technologies, LLC, Dearborn, MI (US)

(72) Inventors: Brock Dunlap, Dearborn, MI (US); Patrick Daniel Maguire, Ann Arbor, MI (US); Deanna Marie Winton Hoffman, Ann Arbor, MI (US); Michael E. Reibling, Sterling Heights, MI (US); Mohammadreza Eftekhari, Novi, MI (US); Adam Denlinger, Saline, MI (US); Alex Revels, Canton, MI (US); David Wilson, South Lyon, MI (US)

(21) Appl. No.: 18/155,404

(22) Filed: Jan. 17, 2023

Related U.S. Application Data
(60) Provisional application No. 63/403,445, filed on Sep. 2, 2022.

(51) Int. Cl. H01M 50/367; B60L 50/64; H01M 50/211; H01M 50/249; H01M 50/271; H01M 50/317

(52) U.S. Cl. CPC H01M 50/367; B60L 50/64; H01M 50/211; H01M 50/249; H01M 50/271; H01M 50/317; B60K 1/04; H01M 2220/20

(57) ABSTRACT

A battery pack venting assembly includes a first beam establishing a first side of a passageway and a second beam establishing an opposite, second side of the passageway. The passageway is configured to communicate battery cell vent byproducts. A method of establishing a vent path within a traction battery pack includes, within an enclosure assembly of a battery pack, providing a cross-member assembly having a first beam and a second beam; and communicating battery cell vent byproducts through at least one opening in the first beam into a passageway having a perimeter that is at least partially provided by the first beam and the second beam.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to beams that help to establish passageways for communicating vent byproducts from a battery pack.

### BACKGROUND

A traction battery pack of an electrified vehicle can include groups of battery cells arranged in one or more cell stacks. From time to time, pressure and thermal energy within one or more of the battery cells can increase. Vent byproducts such as gas and debris can then be released from those battery cells.

### SUMMARY

In some aspects, the techniques described herein relate to a battery pack venting assembly, including: a first beam establishing a first side of a passageway; and a second beam establishing an opposite, second side of the passageway, the passageway configured to communicate battery cell vent byproducts.

In some aspects, the techniques described herein relate to a battery pack venting assembly, wherein an enclosure cover provides a vertically upper side of the passageway.

In some aspects, the techniques described herein relate to a battery pack venting assembly, wherein a thermal exchange plate, an enclosure tray, or both, provide a vertically lower side of the passageway.

In some aspects, the techniques described herein relate to a battery pack venting assembly, wherein the first beam and the second beam are each adhesively secured to the enclosure cover.

In some aspects, the techniques described herein relate to a battery pack venting assembly, further including a first cell stack and a second cell stack, the first beam and the second beam providing portions of a cross-member assembly disposed between the first cell stack and the second cell stack.

In some aspects, the techniques described herein relate to a battery pack venting assembly, wherein the first beam includes a plurality of first openings configured to receive battery cell vent byproducts from at least one battery cell of the first cell stack, wherein the second beam includes a plurality of second openings configured to receive battery cell vent byproducts from at least one battery cell of the second cell stack.

In some aspects, the techniques described herein relate to a battery pack venting assembly, wherein the passageway is configured to communicate the battery cell vent byproducts to at least one exhaust valve in an enclosure assembly.

In some aspects, the techniques described herein relate to a battery pack venting assembly, wherein the at least one exhaust valve extends through a floor of an enclosure tray of the enclosure assembly such that the battery cell vent byproducts are expelled vertically downward from the enclosure assembly.

In some aspects, the techniques described herein relate to a battery pack venting assembly, wherein the passageway, the first beam, and the second beam each extends longitudinally in a cross-vehicle direction.

In some aspects, the techniques described herein relate to a battery pack venting assembly, wherein the passageway is configured to communicate the battery cell vent byproducts to a channel provided by a member that is oriented transversely to the passageway, the channel configured to communicate the battery cell vent byproducts to an opening in an enclosure.

In some aspects, the techniques described herein relate to a battery pack venting assembly, wherein the passageway is a first passageway, wherein the member is configured to receive battery cell vent byproducts from a plurality of second passageways provided by other first and second beams.

In some aspects, the techniques described herein relate to a battery pack venting assembly, wherein the first beam and the second beam each have a C-shaped cross-section.

In some aspects, the techniques described herein relate to a battery pack venting assembly, wherein the first beam and the second beam are at least partially pultruded.

In some aspects, the techniques described herein relate to a battery pack venting assembly, wherein the first beam and the second beam are constituents of a cross-member assembly of battery pack.

In some aspects, the techniques described herein relate to a method of establishing a vent path within a traction battery pack, including: within an enclosure assembly of a battery pack, providing a cross-member assembly having a first beam and a second beam; and communicating battery cell vent byproducts through at least one opening in the first beam into a passageway having a perimeter that is at least partially provided by the first beam and the second beam.

In some aspects, the techniques described herein relate to a method, wherein an upper side of the perimeter is established by an enclosure cover.

In some aspects, the techniques described herein relate to a method, further including communicating the battery cell vent byproducts from the passageway through at least one exhaust valve in the enclosure assembly.

In some aspects, the techniques described herein relate to a method, wherein the at least one exhaust valve extends through a floor of an enclosure tray of the enclosure assembly such that the battery cell vent byproducts are expelled vertically downward from the enclosure assembly.

In some aspects, the techniques described herein relate to a method, further including communicating the battery cell vent byproducts through the passageway to an outboard side of the traction battery pack and into a member that is oriented transverse to the passageway.

In some aspects, the techniques described herein relate to a method, further including communicating the battery cell vent byproducts through the member.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 illustrates a perspective view of a portion of the battery pack of FIG. 2 with the enclosure assembled and with areas cut away to show an outboard region of a cross-member assembly.

FIG. 4 illustrates an end view of the portion of the battery pack shown in FIG. 3.

FIG. 5 illustrates a beam from the cross-member assembly shown in FIGS. 3 and 4.

FIG. 6 illustrates an overhead view of a portion of the battery pack of FIG. 2 with an enclosure cover removed and schematically showing vent byproducts being expelled from the battery pack as exhaust.

FIG. 7 illustrates an overhead view of a portion of a battery pack with an enclosure cover removed and schematically showing vent byproducts being expelled from the battery pack as exhaust according to another exemplary aspect of the present disclosure.

FIG. 8 illustrates an overhead view of a portion of a battery pack with an enclosure cover removed according to yet another exemplary aspect of the present disclosure.

FIG. 9 illustrates a section view at line 9-9 in FIG. 8 and schematically showing vent byproducts being expelled from the battery pack as exhaust.

### DETAILED DESCRIPTION

This disclosure details exemplary venting assemblies for a traction battery pack. The venting assemblies are provided by cross-member assemblies. The venting assemblies establish at least one passageway that helps to communicate battery cell vent byproducts from the traction battery pack.

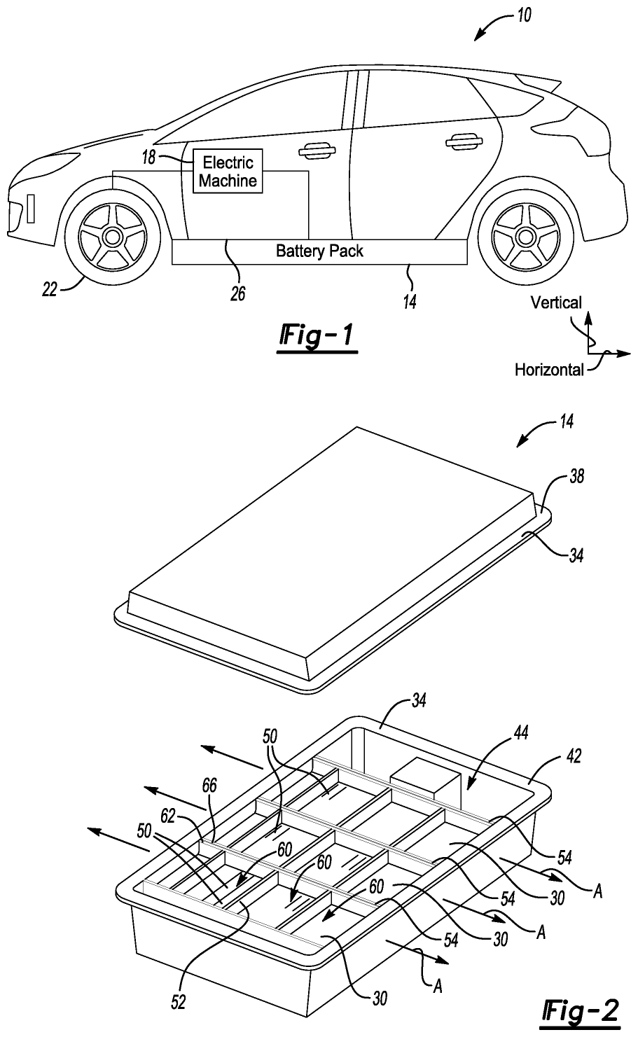

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

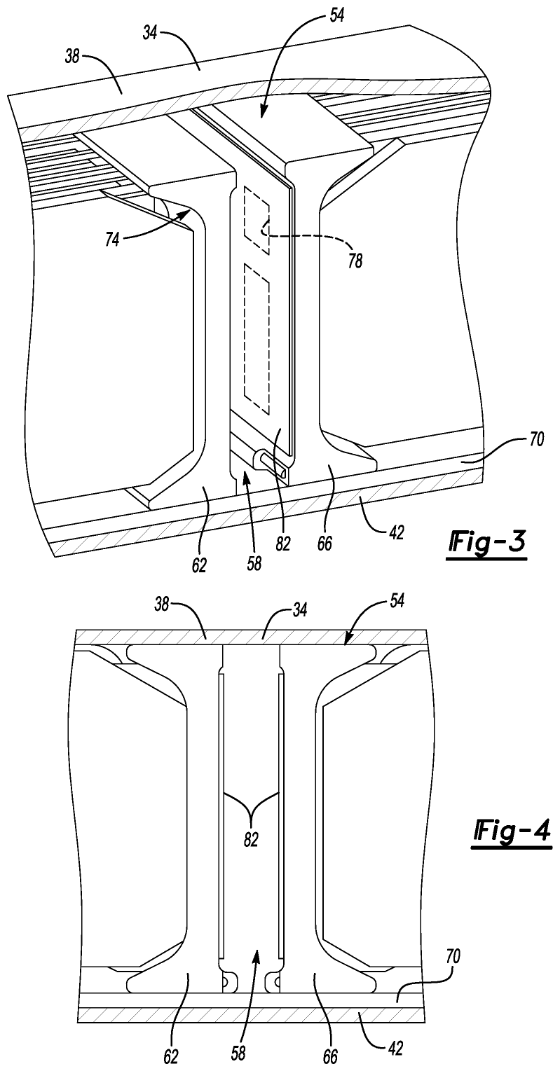

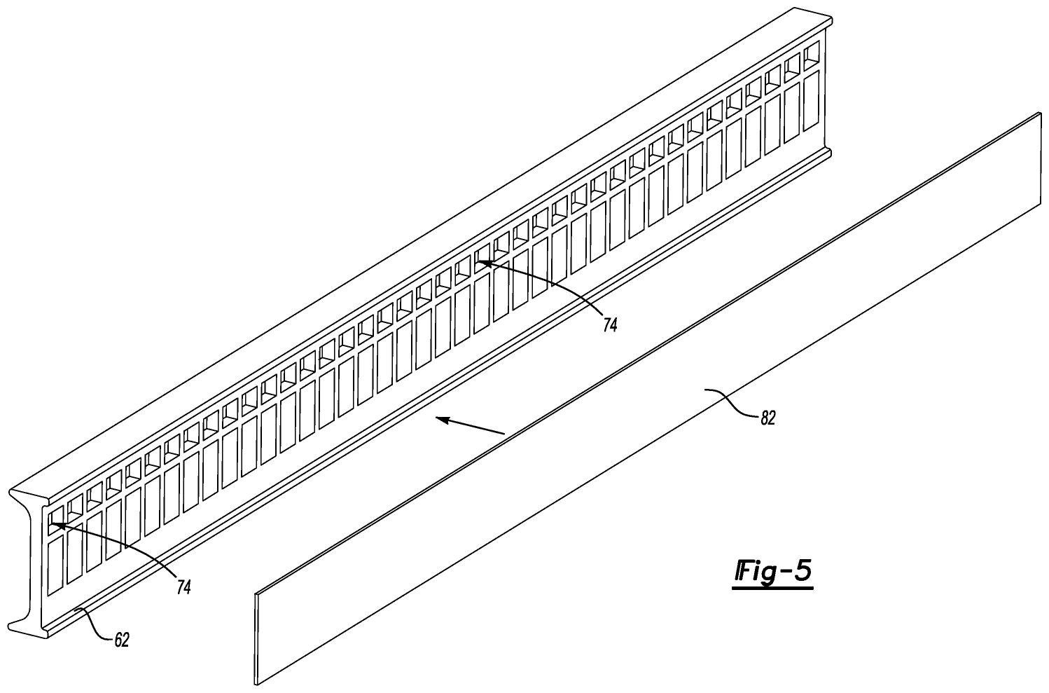

With reference now to FIGS. 2-5, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes a plurality of battery cells 50 (or simply “cells”) and at least one divider 52 distributed along a respective cell stack axis A. The battery cells 50 are stacked side-by-side relative to each along the cell stack axis A. The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure. The exemplary battery cells 50 can include tab terminals extending from a battery cell housing. An aluminum film can provide the housing, for example.

From time to time, pressure and thermal energy within one or more of the battery cells 50 can increase. The pressure and thermal energy increase can be due to, for example, an overcharge condition. The pressure and thermal energy increase can cause the associated battery cell 50 to rupture and release battery cell vent byproducts (e.g., gas and debris) from within the interior of that battery cell 50.

In some examples, the vent byproducts are released from the battery cell 50 through a designated vent within the housing, such as a membrane that yields in response to an increased pressure. The vent byproducts can instead or additionally be released though a ruptured area of the associated battery cell 50.

The battery pack includes a plurality of cross-member assemblies 54 that are configured to transfer a load applied to a side of the vehicle 10, for example. The cross-member assemblies 54 enhance the structural integrity of the battery pack 14.

The cross-member assembles 54 also provide a battery pack venting assembly that helps to communicate the battery cell vent byproducts from the traction battery pack 14. The cross-member assemblies 54 are disposed between the cell stacks 30. The cross-member assemblies 54 establish passageways 58 that communicate the vent byproducts from the cell stacks 30 toward a position where the vent byproducts can be expelled from the battery pack 14.

Within each of the cell stacks 30, the dividers 52 compartmentalize at least one battery cell 50. The compartmentalizing substantially encloses at least one battery cell 50 within a compartment 60 defined by the enclosure assembly 34, cross-member assemblies 54, and the dividers 52. The compartmentalizing effectively encloses groups of the battery cells 50 within various compartments 60.

The compartments 60 can each hold one or more of the battery cells 50 within one of the cell stacks 30. In the exemplary embodiment, the battery cells 50 of each cell stack 30 are held within one of four compartments 60. Other numbers of the compartments 60 could be used in other examples.

In the exemplary embodiment, the cross-member assemblies 54 each include a first beam 62 and a second beam 66. The first beam 62 establishes a first side of the passageway 58. The second beam 66 establishes an opposite second side of the passageway 58. The first beam 62 and the second beam 66 can provide attachment locations for busbar modules and other components.

A vertically upper side of the passageway 58 is established by the enclosure cover 38. A vertically lower side of the passageway 58 is established by, in this example, a thermal exchange plate 70 resting on the enclosure tray 42. In another example, the thermal exchange plate 70 is omitted and the vertically lower side of the passageway 58 is established by the enclosure tray 42. Vertical and horizontal, for purposes of this disclosure, are with reference to ground and a general orientation of battery pack 14 when installed within the vehicle 10 of FIG. 1.

In this example, the first beam 62 and second beam 66 are adhesively secured to the enclosure cover 38 and to the thermal exchange plate 70. The adhesive can seal these interfaces to inhibit vent byproducts escaping the passageway 58 through these areas.

The first beam 62 includes a plurality of openings 74 that are configured to receive battery cell vent byproducts from one of the cell stacks 30. The second beam 66 includes a plurality of openings 78 configured to receive battery cell vent byproducts from another one of the cell stacks 30. The openings 74 and 78 provided a path for battery cell vent byproducts to move to the passageway 58 as required.

When the battery cells 50 in the cell stacks 30 are not venting, the openings 74 and 78 can be covered by a membranes 82 or one-way valves, for example. A pressure differential increase associated with one or more of the battery cells 50 venting can rupture the membrane 82 so that the vent byproducts can pass through one or more of the openings 74 or 78 into the passageway 58.

Unruptured areas of the membrane 82 continue to cover openings 74 and 78 that are not needed to permit venting. The membrane 82 continuing to cover these openings 74 and 78 can block vent byproducts from moving from the passageway 58 through those openings 74 or 78 and next to battery cells 50 that are not venting. This can help to inhibit vent byproducts from battery cells 50 that are venting moving near cells 50 that are not venting and causing a thermal event to cascade to those cells 50 that are not venting. The membrane 82 can be comprised of several smaller segments. This allows a membrane segment to fall away from one or more of the battery cells 50 that are venting without risking adjacent segments being pulled away from adjacent battery cells 50 that are not venting.

In this example, the cross-member assemblies 54 and the respective passageways 58 extend longitudinally in a cross-vehicle direction. At positions longitudinally between the openings 74 and 78, a complete circumferential perimeter of the passageway 58 is established by the first beam 62, the enclosure cover 38, the second beam 66, and the thermal exchange plate 70. In the areas of the cross-member assemblies 54 longitudinally aligned with the openings 74 and 78, the membranes 82 can establish part of the perimeter of the passageway 58.

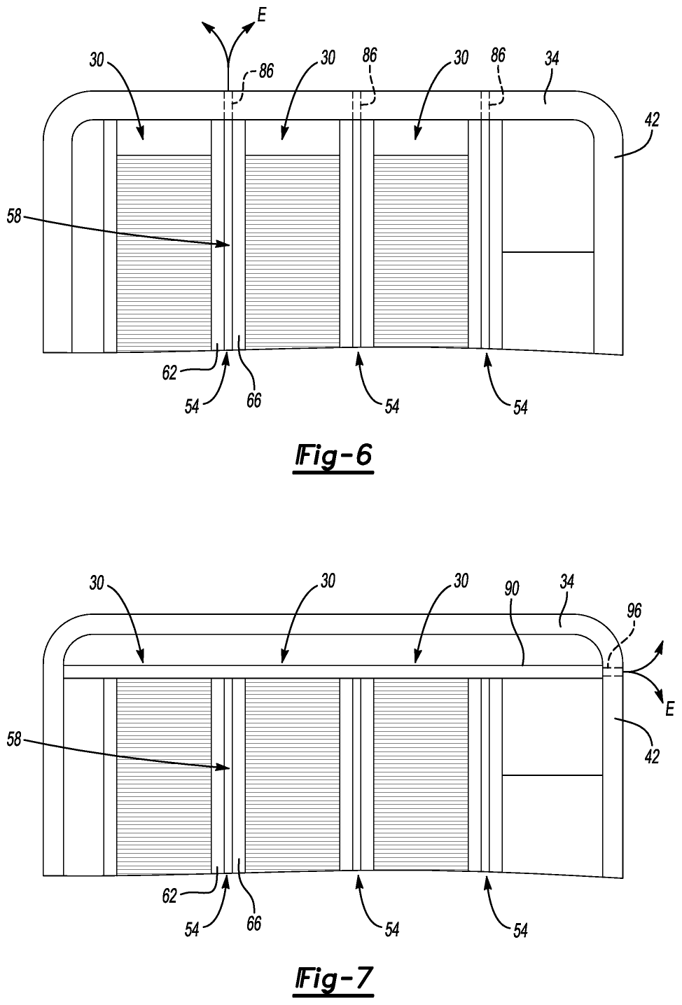

With reference to FIG. 6 and continuing reference to FIGS. 1-5, the passageways 58 are configured to communicate the vent byproducts outboard to the outboard sides of the vehicle 10. In this example, the passageways 58 communicate the vent byproducts to a respective exhaust valve 86 within the enclosure assembly 34. The exhaust valve 86 releases the vent byproduct as exhaust E to areas surrounding the traction battery pack 14.

With reference to FIG. 7 and continuing reference to FIGS. 1-5, in another exemplary embodiment, the battery pack 14 includes at least one member 90 or “megabar” at an outboard side of the battery pack 14. The passageways 58 of the battery pack 14 are each configured to communicate vent byproducts to a channel within the member 90. Put another way, the member 90 is configured to receive vent byproducts from each of the passageways 58 within the battery pack 14. The cross-member assemblies 54 can be mechanically fastened to the member 90 having the channel. The member 90 extends longitudinally parallel to a longitudinal axis of the vehicle 10 and is thus oriented transverse to the passageways 58 of the cross-member assemblies 54.

The vent byproducts move through the channel provided by the member 90 to an exhaust valve 96, which releases the vent byproducts from the traction battery pack 14 as exhaust E. The exhaust valve 96 can be located at a rear of the battery pack 14 with reference to an orientation of the vehicle 10. Positioning the exhaust valve 96 in this area can help to inhibit the vent byproducts from flowing over the battery pack 14 or near a passenger compartment of the vehicle 10.

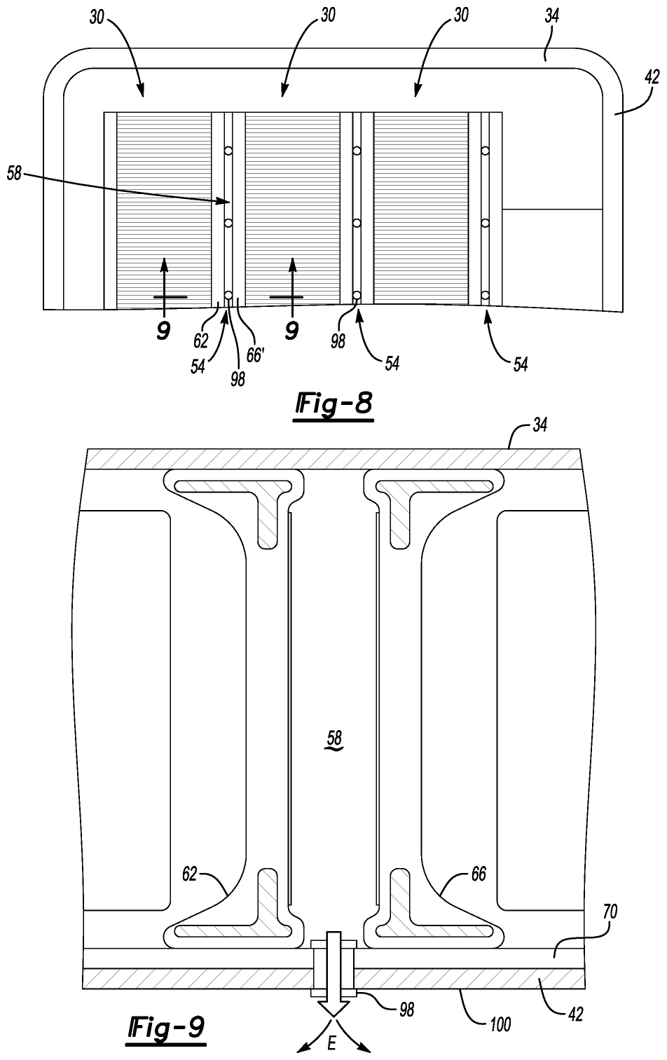

With reference now to FIGS. 8 and 9 and with continuing reference to FIGS. 1-5, in another exemplary embodiment, exhaust valves 98 open to the passageway 58 and extend through the thermal exchange plate 70 and a floor 100 of the enclosure tray 42 to an exterior of the battery pack 14. The valves 98 permit releasing of the vent byproducts vertically downward through the floor 100 of the enclosure assembly 34 as exhaust E.

In the exemplary embodiments of this disclosure, the first beam 62 and second beam 66 each have a general C-shaped cross-section. This cross-section can facilitate providing the passageway 58.

The first beams 62 and the second beams 64 are structural beams that can help to handle tension loads from cell expansion and compression load from impact events. The first beams 62 and the second beams 66 can be pultruded beams, which implicates structure to these beams. The skilled person would understand how to structurally distinguish a pultruded beam from another type of beam, such as an extruded beam.

The first beams 62 and the second beams 64 could be made with pultrusion process with continuous fiber glass, carbon or basalt with a thermoset resin. The first beams 62 and the second beams 64 could be injection molded or compression molded with glass, carbon or basalt fibers and a thermoplastic resin. The structural element of the first beams 62 and the second beams 64 could also be made from extruded aluminum or rolled steel, which is overmolded with plastic to make a final beam assembly. The first beams 62 and the second beams 64 could also bond to the enclosure 34 and thermal exchange plate 70 with adhesive.

The first beam 62 and the second beam 66 can include a plurality of glass strands that are pulled through a thermoset resin. Portions of the first beam 62 and the second beam 66 can then be overmolded to provide a desired cross-section.

For any of the above exemplary embodiments, an example method of establishing a vent path includes providing a cross-member assembly having a first beam and a second beam, and then communicating battery cell vent byproducts through at least one opening in the first beam into a passageway of the cross-member assembly. The passageway having a perimeter that is at least partially provided by the first beam and the second beam.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack venting assembly, comprising:
a first beam establishing a first side of a passageway; and
a second beam establishing an opposite, second side of the passageway, the passageway configured to communicate battery cell vent byproducts.

2. The battery pack venting assembly of claim 1, wherein an enclosure cover provides a vertically upper side of the passageway.

3. The battery pack venting assembly of claim 2, wherein a thermal exchange plate, an enclosure tray, or both, provide a vertically lower side of the passageway.

4. The battery pack venting assembly of claim 2, wherein the first beam and the second beam are each adhesively secured to the enclosure cover.

5. The battery pack venting assembly of claim 1, further comprising a first cell stack and a second cell stack, the first beam and the second beam providing portions of a cross-member assembly disposed between the first cell stack and the second cell stack.

6. The battery pack venting assembly of claim 5, wherein the first beam includes a plurality of first openings configured to receive battery cell vent byproducts from at least one battery cell of the first cell stack, wherein the second beam includes a plurality of second openings configured to receive battery cell vent byproducts from at least one battery cell of the second cell stack.

7. The battery pack venting assembly of claim 1, wherein the passageway is configured to communicate the battery cell vent byproducts to at least one exhaust valve in an enclosure assembly.

8. The battery pack venting assembly of claim 7, wherein the at least one exhaust valve extends through a floor of an enclosure tray of the enclosure assembly such that the battery cell vent byproducts are expelled vertically downward from the enclosure assembly.

9. The battery pack venting assembly of claim 1, wherein the passageway, the first beam, and the second beam each extends longitudinally in a cross-vehicle direction.

10. The battery pack venting assembly of claim 1, wherein the passageway is configured to communicate the battery cell vent byproducts to a channel provided by a member that is oriented transversely to the passageway, the channel configured to communicate the battery cell vent byproducts to an opening in an enclosure.

11. The battery pack venting assembly of claim 10, wherein the passageway is a first passageway, wherein the member is configured to receive battery cell vent byproducts from a plurality of second passageways provided by other first and second beams.

12. The battery pack venting assembly of claim 1, wherein the first beam and the second beam each have a C-shaped cross-section.

13. The battery pack venting assembly of claim 1, wherein the first beam and the second beam are at least partially pultruded.

14. The battery pack venting assembly of claim 1, wherein the first beam and the second beam are constituents of a cross-member assembly of battery pack.

15. A method of establishing a vent path within a traction battery pack, comprising:
within an enclosure assembly of a battery pack, providing a cross-member assembly having a first beam and a second beam; and
communicating battery cell vent byproducts through at least one opening in the first beam into a passageway having a perimeter that is at least partially provided by the first beam and the second beam.

16. The method of claim 15, wherein an upper side of the perimeter is established by an enclosure cover.

17. The method of claim 15, further comprising communicating the battery cell vent byproducts from the passageway through at least one exhaust valve in the enclosure assembly.

18. The method of claim 17, wherein the at least one exhaust valve extends through a floor of an enclosure tray of the enclosure assembly such that the battery cell vent byproducts are expelled vertically downward from the enclosure assembly.

19. The method of claim 15, further comprising communicating the battery cell vent byproducts through the passageway to an outboard side of the traction battery pack and into a member that is oriented transverse to the passageway.

20. The method of claim 19, further comprising communicating the battery cell vent byproducts through the member.
